(19) United States
(12) Patent Application Publication
(10) Pub. No.: US 2023/0001507 A1
(43) Pub. Date: Jan. 5, 2023

(54) APPARATUS FOR LASER-DEPOSITION WELDING WITH MULTIPLE LASER-DEPOSITION WELDING HEADS

(71) Applicant: HPL Technologies GMBH, Aachen (DE)

(72) Inventor: Phillip UTSCH, Wetzlar (DE)

(73) Assignee: HPL Technologies GMBH, Aachen (DE)

(21) Appl. No.: 17/779,751

(22) PCT Filed: Nov. 10, 2020
(86) PCT No.: PCT/DE2020/100961

§ 371 Date: May 25, 2022

(30) Foreign Application Priority Data
Nov. 27, 2019 (DE) 10 2019 132 191.3

(51) Int. Cl. B23K 26/08; B23K 26/70

(52) U.S. Cl. CPC B23K 26/0823; B23K 26/70

(57) ABSTRACT

The invention relates to an apparatus for laser-deposition welding with multiple laser-deposition welding heads and to a method for operating such an apparatus comprising a laser-deposition welding unit with multiple laser-welding heads arranged thereon for the (quasi-) simultaneous depositing of material (M) onto a surface of a component and also comprising one or more conveying units for supplying the laser-deposition welding heads with the material (M) to be applied and further comprising one or more laser-radiation sources for supplying the laser-deposition welding heads with laser radiation (L) for carrying out the laser-deposition welding.

### FIELD OF THE INVENTION

The invention relates to an apparatus for laser-deposition welding with multiple laser-deposition welding heads and to a method for operating such an apparatus.

### BACKGROUND OF THE INVENTION

Laser-deposition welding is a method for surface treatment (e.g. coating, repair) and additive manufacturing of components with filler materials in wire or powder form. Due to greater resilience to adjustment errors in the process setup and greater flexibility in material selection, filler materials in powder form are predominantly used. The powder is introduced, by means of a powder nozzle at a defined angle, into a molten pool created by a laser beam on a surface of a component. During the interaction between laser radiation and powder particles above the molten pool, a portion of the laser radiation is absorbed by the powder. The non-absorbed portion is reflected or transmitted (several times). The portion of radiation absorbed by the powder particles causes the powder particles to heat up, and the transmitted portion of radiation creates the molten pool. Depending on the degree to which the particles are heated in the zone of beam-substance interaction, the particles of the filler material are solid and/or partially or completely liquid before they enter the molten pool.

If the component is then moved relative to the laser and the powder feed, the material of the molten pool moves out of the area of influence of the laser radiation and solidifies to form a layer. The prerequisite for producing defect-free layers bonded by melt metallurgy is to provide a process heat that is sufficient to initiate a temperature-time cycle that ensures that both the substrate and the filler material are melted. The filler material and component material are therefore mixed to a greater or lesser extent depending on the laser power and the setting of other process parameters (e.g. feed rate, track distance, beam diameter, material feed, etc.). The powder can be injected laterally or coaxially into the melt pool. With the customary process control, it is possible to achieve feed rates, that is relative speeds of the component in relation to the laser beam, of typically between 0.2 m/min and 2 m/min. In the method disclosed in DE 10 2011 100 456 B4, the supplied material is already melted above the surface by means of an appropriately focused laser beam with high power, such that it reaches the molten pool on the surface of the component already in the molten state, which enables faster processing of the component through further increased feed rates in the range of ≥150 m/min. In the method according to DE 10 2011 100 456 84, the area coverage rate is now higher (and thus the coating time is shorter) than in the conventional procedure, but the high cooling rates due to the increased feed rate favour the formation of cracks (stress cracks due to the shrinkage stresses). As a result, many alloys, in particular difficult-to-weld alloys mainly for wear protection, can no longer be processed. Despite providing a larger area coverage rate, DE 10 2011 100 456 84 does not offer any approaches for increasing the deposition rate (amount of powder deposited per unit of time).

By applying preheating to the component, the tendency to crack can in principle be reduced and the deposition rate increased. EP 0 190 378 A1 discloses that faster processing of the component can be achieved by subjecting the entire component to additional thorough preheating in a furnace before the treatment described above. The preheating temperature of the furnace heating is up to 600° C. This allows the material to be deposited at a feed rate of up to 5.4 m/min. EP 1 285 719 A1 discloses a modified preheating method that allows significantly higher feed rates to be achieved while simultaneously avoiding cracks in the layer or substrate material. In this method, the workpiece is inductively heated during laser-deposition welding. The use of inductive preheating restricts its use to components with a suitable geometry. DE102011100456 84. It would be desirable to avoid time-consuming preheating procedures or additionally required components such as inductive heaters.

It would therefore be desirable to have an effective laser-deposition welding process available that enables a higher deposition rate for a wide range of materials with less process time for the component.

### SUMMARY OF THE INVENTION

It is therefore an object of the invention to provide an effective laser-deposition welding process that enables a higher deposition rate for a wide range of materials with less process time for the component.

This object is achieved by an apparatus for laser-deposition welding having a laser-deposition welding unit with multiple laser welding heads arranged thereon for (quasi-)simultaneous depositing of material onto a surface of a component and having one or more conveying units for supplying the laser-deposition welding heads with the material to be deposited and having one or more laser beam sources for supplying the laser-deposition welding heads with laser radiation for carrying out the laser-deposition welding.

With regard to terminology, the following should be explained:

First, it should be expressly pointed out that, in the context of the present patent application, indefinite articles and numerical indications such as “one”, “two”, etc. are generally to be understood as “at least” indications, i.e. as “at least one . . . ”, “at least two . . . ”, etc., unless it expressly follows from the respective context or it is obvious or technically imperative for the skilled person that only “exactly one . . . ”, “exactly two . . . ”, etc. can be meant in this case.

The term “laser-deposition welding” refers to all methods in which a material passing through a laser-deposition welding head in the direction of the component to be processed, for example a material in powder form, is melted, in a molten pool created by the laser beam on the surface of the component, by means of a laser beam which is also guided through the material by the laser-deposition welding head in the direction of the component to be processed, and is thus deposited onto the surface of the component which has also been melted by the laser beam. The subsequently solidified material remains there as material welded to the surface. The laser-deposition welding head comprises, for example, an optical system for the laser beam and a powder feed nozzle including an adjustment unit for the material to be deposited, optionally with an integrated, local protective gas supply. The laser beam can also be guided in such a way that the material is already melted in the laser beam, for example by a laser beam that has a focal point above the surface of the component.

The term “laser-deposition welding unit” means a component comprising the laser-deposition welding heads. In this respect, the laser-deposition welding heads can, for example, be attached to a carrier plate of the laser-deposition welding unit. Preferably, the attachment can be designed in such a way that the laser-deposition welding heads can move relative to one another. In addition, the laser-deposition welding unit as a whole can be arranged so as to be spatially movable in the apparatus, for example on an adjustment unit of the apparatus. As an embodiment, the laser-deposition welding unit can be arranged on a robot arm that can move the laser-deposition welding unit spatially as desired by means of suitable traversing curves. The number of laser-deposition welding heads is at least two in this case. It is therefore also possible for three, four, five or more laser-deposition welding heads to be included in the laser-deposition welding unit. The number of laser-deposition welding heads that can be present in the apparatus is usually a geometrical problem and is determined by the size of the laser-deposition welding heads and the component to be processed.

The term “laser-deposition welding head” refers to the unit which, by means of the laser beam passing through it, creates a laser welding spot on the surface of the component to be processed and which melts the material in the laser beam, which material also passes through said unit on its path to the surface of the component such that it is welded to the component upon impact with the surface of the latter.

The material deposited can, for example, be provided in powder form for laser-deposition welding. The material may be any material suitable for laser-deposition welding. For example, the material may comprise or consist of metals and/or metal-ceramic composites (so-called MMCs). The skilled person can select the materials suitable for the respective laser-deposition welding process. In this case, the material can be fed to the laser heads from a single conveying unit. However, the apparatus can also comprise several conveying units, whereby the laser-deposition welding heads can be supplied with different materials, such that the deposition welding tracks produced by different laser-deposition welding heads can comprise the same or different materials, or the material feed to one or more laser-deposition welding heads can, during laser-deposition welding, be changed or switched from one conveying unit to another conveying unit with a different material.

The laser radiation is provided by means of one or more laser beam sources. The skilled person can select suitable laser beam sources for laser-deposition welding.

The term “(quasi-)simultaneous deposition” refers to the process of laser-deposition welding, whereby, for each laser-deposition welding head, separate deposition welding tracks are deposited onto the surface at the same time as (preceding or following) other deposition welding tracks by means of other laser-deposition welding heads. This (quasi-)simultaneous deposition takes place at the same time, but at other positions on the component, i.e. at different locations on the component. Thus, the material deposited onto the surface per unit of time increases proportionally with the number of laser-deposition welding heads. The separate deposition welding tracks can adjoin or, optionally, at least partially overlap one another. Optionally, the separate deposition welding tracks can also be deposited directly on top of one another. For example, the apparatus according to the invention can be used to reduce previously common processing times of 3-15 minutes to less than 1 minute when processing brake discs by means of laser-deposition welding.

Through the (quasi-)simultaneous deposition of material by means of multiple laser-deposition welding heads, the apparatus according to the invention thus enables an effective laser-deposition welding process, which enables a higher deposition rate for a wide range of materials with a shorter process time for the component than would be possible with only one laser welding head. In order to achieve a shorter process time, the feed rate does not need to be increased compared to known methods, which improves the quality of the deposited layer and helps to avoid layer defects such as the formation of cracks by means of a feed rate appropriate to the process.

In one embodiment, the laser-deposition welding heads each produce a laser welding spot on the surface of the component, and adjacent laser welding spots have a first offset from one another perpendicular to a feed direction of the laser welding spots on the surface of the component. The expression “on the surface of the component” refers to the current surface of the component at the time when the respective laser welding spot sweeps over the surface. The surface of the component need not be the original surface of the component before laser-deposition welding begins. The surface of the component can also be the surface of a deposition welding track that has already been deposited or of a layer of deposited material, as this is welded to the previous surface after being deposited and thus in itself constitutes the surface of the component for subsequent deposition welding tracks. The term “laser welding spot” refers to the spatial location on the surface of the component where the molten material is deposited onto the surface by means of laser-deposition welding. The laser welding spot can also be referred to as the melting area of the deposited material, where the material melted by laser radiation meets the surface of the component. The term “adjacent laser welding spots” refers to two laser welding spots which produce deposition welding tracks of material applied to the surface of the component, and which can adjoin and optionally overlap one another at least partially to produce an areal deposition of the material. Adjacent laser-deposition welding spots can be produced by adjacent laser-deposition welding heads. In this case, adjacent laser welding spots and/or laser-deposition welding heads do not necessarily refer to laser welding spots or laser-deposition welding heads that have the smallest geometric distance from one another, but are or produce those laser welding spots that create adjoining deposition welding tracks. Due to the at least first offset of the adjacent laser welding spots from one another, the preheating of the component can be controlled in a targeted manner, which makes it easier or, depending on the alloy, even possible to process difficult-to-weld alloys. The at least first offset of a suitable size also reduces the amount of post-processing required. In a further embodiment, the laser welding spots produce deposition welding tracks for the aforementioned purpose with a material width along the feed direction on the surface, in which welding tracks the first offset of adjacent laser welding spots is between 10% and 90%, preferably between 40% and 60%, most preferably 50%, of the material width of the deposition welding track.

In a further embodiment, the adjacent laser welding spots on the surface of the component have a second offset from one another in the feed direction. Due to this second offset of the laser welding points, the preheating of the component can also be controlled in a targeted manner, in particular in conjunction with the first offset, which makes it easier or, depending on the alloy, even possible to process difficult-to-weld alloys. The second offset of suitable size, in particular in conjunction with the first offset, also further reduces the amount of post-processing required.

In one embodiment, the second offset is set in such a way that temperature profiles induced by the laser welding spots on the surface overlap to such an extent that the material in an overlap region of adjacent deposition welding tracks still has a residual heat that is usable/admissible for the process. In this case, the laser welding head with the second offset from the adjacent deposition welding track can be used not only to deposit its own deposition welding track, but also to remelt the deposition welding track deposited adjacent.

In one embodiment, the apparatus is configured, after an areal deposition of the material as a preceding layer onto the surface of the component, to guide the laser-deposition welding heads in such a way that a further areal deposition of the material as a subsequent layer onto the preceding layer is carried out in order to deposit the material as a multilayer system. This makes it easy to produce multilayer systems. These multilayer systems can consist of the same or different materials. Multilayer systems can be used to produce layers with a greater layer thickness than would be possible with a single-layer system, or to deposit multiple different functional layers through a common process. In this case, the deposition process for the subsequent layer can be used to remelt the most recently deposited layer in order to modify its properties as desired. Using the apparatus according to the invention, layer thicknesses of 0.3 mm to 3.0 mm per layer can typically be deposited. If greater layer thicknesses are desired, these can be achieved by depositing multiple layers of the same material on top of one another. The same applies to layers of different materials.

In a further embodiment, the deposition welding tracks of the subsequent layer are deposited onto the preceding layer with a third offset perpendicular to the feed direction relative to the underlying deposition welding tracks of the preceding layer. This means, for example, that the contours of the individual layers can overlap in such a way that the surface of the multilayer system has an undulation lower than the undulations of the respective individual layers, which reduces the intensity of any necessary post-processing steps such as sanding and smoothing.

In a further embodiment, the deposited layers have a varying layer thickness, with a smaller layer thickness and a larger layer thickness, wherein the third offset of the deposition welding tracks of superimposed layers is set in such a way that the larger layer thicknesses of the subsequent layer are arranged above the smaller layer thicknesses of the preceding layer. This means that the surface of the multilayer system can be provided with a very small contour or a very small surface unevenness or roughness. This makes post-processing steps such as grinding to smooth the surface of the deposited material in the multilayer system less time-consuming or, where applicable, even obsolete.

In a further embodiment, the apparatus is configured to supply, by suitable control of the conveying units, the laser-deposition welding heads with different materials for deposition onto the surface of the component. As a result, adjacent deposition welding tracks from different laser welding heads can consist of different materials, and different layers in a multilayer system can be made from different materials.

In a further embodiment, the control for this purpose is carried out in such a way that layers of a multilayer system consist of different materials, with first layers of a first material and second layers of a second material. This means that if components are processed using laser-deposition welding, for example, a first layer of a first material and a second layer of a second material can be deposited onto the first layer. In this case, the second layer can be, for example, an anti-corrosion layer made of a corrosion-resistant material to protect the properties of the first layer. In another example, the second layer could also be an abrasion layer, for example for brake discs. In this instance, to increase the layer thickness, the preceding first and second layers may themselves each be a multilayer system made of layers of the same material in each case.

In a further embodiment, the laser-deposition welding unit is, in order to perform a movement relative to the surface of the component, arranged in the apparatus so as to be movable, preferably by means of a movement unit. This allows components to be flexibly processed by area by guiding the laser-deposition welding unit over a surface, for example on a rotating surface or along a rotating shaft.

In a further embodiment, the laser-deposition welding heads are, in order to perform a movement relative to one another, arranged in the apparatus so as to be movable, preferably by means of a laser-deposition welding head movement unit. This allows the individual deposition welding tracks to be precisely guided relative to one another and across the surface of the component to be processed.

In a further embodiment, the apparatus comprises a control unit designed to suitably control at least the movements of the laser-deposition welding unit and/or of the laser-deposition welding heads and/or the conveying units and/or of the laser beam sources in order to carry out the laser-deposition welding, for which purpose the control unit is suitably connected to these components. The control unit may be a software-based machine controller on which an appropriate control program is installed and executed accordingly to control the process.

The invention further relates to a method for operating an apparatus for laser-deposition welding according to the invention, having a laser-deposition welding unit with multiple laser-deposition welding heads arranged thereon, comprising the step of (quasi-)simultaneously depositing material onto a surface of a component. Through the (quasi-)simultaneous deposition of material by means of multiple laser-deposition welding heads, the method provides an effective laser-deposition welding process which enables a higher deposition rate for a wide range of materials with a shorter process time for the component than would be possible with only one laser welding head, in order to achieve a shorter process time, the feed rate does not need to be increased compared to known methods, which improves the quality of the deposited layer and helps to avoid layer defects such as the formation of cracks by means of a feed rate appropriate to the process.

In one embodiment of the method, the laser-deposition welding heads each produce a laser welding spot on the surface of the component, wherein the method comprises the further step of moving adjacent laser welding spots with a first offset from one another perpendicular to a feed direction of the laser welding spots on the surface of the component.

In a further embodiment, the method comprises the further step of moving adjacent laser welding spots on the surface of the component with a second offset from one another in the feed direction.

In a further embodiment, the method comprises the further step of controlling at least the movements of the laser-deposition welding unit and/or of the laser-deposition welding heads and/or of the conveying units and/or of the laser beam sources in order to carry out the laser-deposition welding by means of a control unit suitably connected to these components.

In a further embodiment, the method comprises the further step of depositing a multilayer system onto the surface of the component by suitably guiding the laser-deposition welding heads of the apparatus, in which, after an areal deposition of the material as a preceding layer onto the surface of the component, a further areal deposition of the material as a subsequent layer onto the preceding layer takes place.

In a further embodiment of the method, wherein the deposited layers of the multilayer system have a varying layer thickness with a smaller layer thickness and a larger layer thickness, said method comprises the further step of setting a third offset perpendicular to the feed direction between deposition welding tracks of the subsequent layer and underlying deposition welding tracks of the preceding layer such that the larger layer thicknesses of the subsequent layer are arranged above the smaller layer thicknesses of the preceding layer.

In a further embodiment, the method comprises the further step of controlling the conveying units for the laser-deposition welding heads in such a way that the layers of the multilayer system consist of different materials, with first layers of a first material and second layers of a second material.

In a further embodiment of the method, wherein the component, preferably a brake disc, comprises a circular surface having a rotation axis onto which the material is deposited, said method comprises the further steps of
rotating the circular surface about the rotation axis under the laser-deposition welding heads such that their laser welding spots on the circular surface would circularly run over the surface when the laser-deposition welding heads are at rest; and
moving the laser-deposition welding heads in the direction of the rotation axis such that the material is deposited in spiral deposition welding tracks by area on the circular surface.

Through the movement of the laser-deposition welding heads in combination with the rotating component, the material is deposited onto the entire area of the component. The speed of the individual movements for the component and laser-deposition welding heads determines, inter alia, the extent to which the adjacent deposition welding tracks overlap one another.

In a further embodiment of the method, wherein the component, preferably a shaft, comprises a rotationally symmetrical surface having a rotation axis onto which the material is deposited, said method comprises the further steps of
rotating the rotationally symmetrical surface, preferably the cylindrical surface of the shaft, about the rotation axis under the laser-deposition welding heads such that their laser welding spots on the rotationally symmetrical surface would circularly run over the surface when the laser-deposition welding heads are at rest; and
moving the laser-deposition welding heads in the feed direction parallel to the rotation axis such that the material is deposited in spiral deposition welding tracks by area on the rotationally symmetrical surface.

Through the movement of the laser-deposition welding heads in combination with the rotating component, the material is also deposited onto the entire area of the component for this component geometry. The speed of the individual movements for the component and laser-deposition welding heads determines, inter alia, the extent to which the adjacent deposition welding tracks overlap one another.

The embodiments listed above can be used individually or in any combination deviating from the references in the claims relative to one another in order to design apparatuses or methods according to the invention.

### BRIEF DESCRIPTION OF THE FIGURES

These and other aspects of the invention are shown in detail in the figures as follows.

FIG. 1: an embodiment of the apparatus according to the invention;

FIG. 2: a top view of a brake disc as an example of a circular component having the dynamic behaviour of the laser welding spots during laser-deposition welding of an apparatus according to the invention, in this embodiment with four laser-deposition welding heads;

FIG. 3: a perspective view of a shaft as an example of a rotationally symmetrical component with the dynamic behaviour of the laser-deposition welding spots during laser-deposition welding of an apparatus according to the invention in this embodiment with three laser-deposition welding heads;

FIG. 4: an exemplary side view of deposition welding tracks deposited by area using the apparatus according to the invention, (a) as a single layer, (b) as a single layer with a larger first offset compared to FIG. 4a, and (c) of a multilayer system; and

FIG. 5: an embodiment of the method according to the invention for operating the apparatus according to the invention.

### DETAILED DESCRIPTION OF THE EXEMPLARY EMBODIMENTS

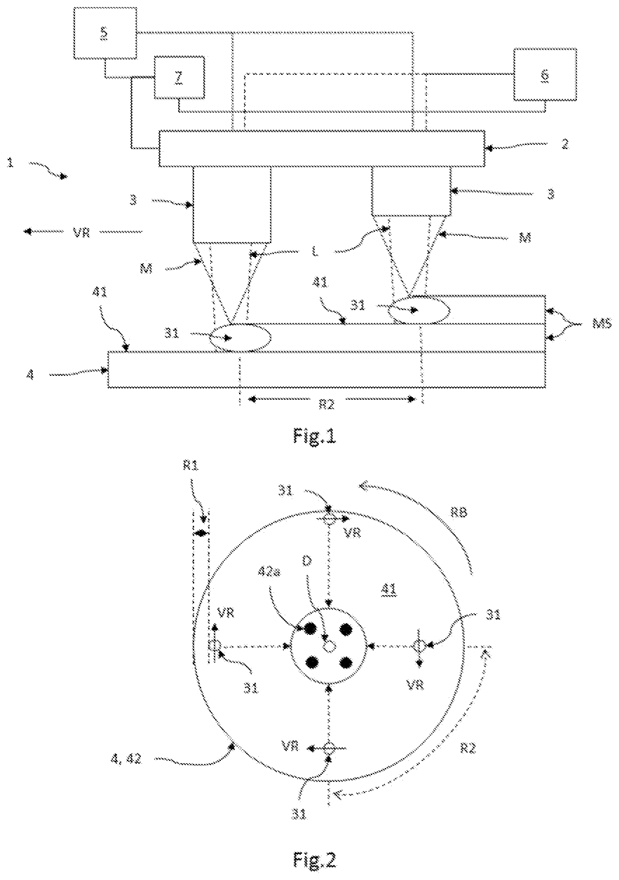

FIG. 1 shows an embodiment of the apparatus 1 for laser-deposition welding according to the invention, having a laser-deposition welding unit 2 with, in this case for example, two laser-deposition welding heads 3 arranged thereon for the (quasi-)simultaneous depositing of material M onto a surface 41 of a component 4 along a respective deposition welding track MS per laser-deposition welding head 3, and having one or more conveying units 5 (shown here symbolically as a unit 5) for supplying the laser-deposition welding heads 3 with the material M to be applied, and having one or more laser beam sources 6 (shown here symbolically as a unit 6) for supplying the laser-deposition welding heads 3 with laser radiation L for carrying out the laser-deposition welding, and having a control unit 7 designed to suitably control at least the movements of the laser-deposition welding unit 2 and/or of the laser-deposition welding heads 3 and/or the conveying units 5 and/or of the laser beam sources 6 in order to carry out the laser-deposition welding, for which purpose the control unit 7 is suitably connected to these components, for example via data lines or other connecting means, indicated by the solid lines. The laser-deposition welding head 3 comprises an optical system for guiding the beam of laser radiation, a powder feed nozzle including an adjustment unit and optionally a local protective gas supply. Suitable laser beam sources for laser-deposition welding are known. The two laser-deposition welding heads 3 shown here each produce a laser welding spot 31 on the original surface 41 of the component 4 and accordingly on the deposition welding track MS of the previously positioned laser-deposition welding head 3, wherein the two laser welding spots 31, relative to the surface 41 of the component 4, have a second offset R2 from one another in the feed direction VR. In this respect, the original surface 41 and the surface of the first deposition welding track MS are both referred to as the surface of the component 41 onto which the material is deposited by means of the deposition welding track MS. Furthermore, although not explicitly shown here, the two laser welding spots 31 may have a first offset R1 from one another perpendicular to a feed direction VR of the laser welding spots 31 on the surface 41 of the component 4. The apparatus 1 can be configured to supply, by suitable control of the conveying units 5, the laser-deposition welding heads 3 with different materials for deposition onto the surface 41 of the component 4. In this case, the apparatus 1 comprises one conveying unit 5 for each different material. To coat the entire area of the component 4 with multiple deposition welding tracks MS arranged next to one another, the laser-deposition welding unit 2 can, in order to perform a movement relative to the surface 41 of the component 4, be arranged in the apparatus 1 so as to be movable, preferably by means of a movement unit. The skilled person is capable of using suitable movement units for the respective components and the material depositions to be produced. In this respect, the laser-deposition welding heads 3 can additionally be arranged in the apparatus 1 so as to be movable relative to one another in order to perform a movement, preferably by means of a laser-deposition welding head movement unit, for which the same applies. The components to be processed can have different geometries and sizes and be made from different materials. Depending on the component to be processed, the number of laser-deposition welding heads used can vary, although at least two laser-deposition welding heads are always used.

FIG. 2 shows a top view of a brake disc 42 as an example of a circular component 4 having the dynamic behaviour of the laser welding spots 31 during laser-deposition welding of an apparatus 1 according to the invention, in this embodiment with four laser-deposition welding heads 3 for (quasi-)simultaneous deposition 110 of material M onto the surface 41 of a component 4. In other embodiments, the number of laser-deposition welding heads may also be two, three, five, six or more, wherein the maximum number is limited only by the size of the laser-deposition welding heads 3 and the available space above the component 4. The four laser-deposition welding heads 3 shown here each produce a laser welding spot 31 on the surface 41 of the component 4, wherein the four laser welding spots 31 have a first offset R1 from one another perpendicular to a feed direction VR of the laser welding spots 31 on the surface 41 of the component 4 and are moved with this first offset over the surface 41 during the method. The laser welding spots 31 thus produce deposition welding tracks MS with a material width MB along the feed direction VR on the surface 41, in which welding tracks the first offset R1 of adjacent laser welding spots 31 is between 10% and 90%, preferably between 40% and 60%, most preferably 50%, of the material width MB of the deposition welding track MS. Furthermore, the adjacent laser welding spots 31 on the surface 41 of the component 4 have a second offset R2 from one another in the feed direction VR, which here is in each case a quarter of the circumference of the brake disc 42 for the respective radial distance of the laser welding spot 31 from the centre point of the brake disc 42, through which the rotation axis D of the brake disc 52 as component 4 passes. The second offset R2 is in this case set in such a way that temperature profiles induced by the laser welding spots 31 on the surface 41 overlap to such an extent that the material M in an overlap region of adjacent deposition welding tracks MS still has a residual heat that is usable/admissible for the process. A usable/admissible residual heat would be, for example, a temperature at which the material of one or more adjacent deposition welding tracks MS can still deform due to the temperature induced in the laser welding spot of the deposition welding track MS just deposited. The brake disc 42 could be mounted by means of the screw holes 42a on a turntable, by which the brake disc 42 is rotated about the rotation axis D. In order to deposit the material M onto the brake disc 42, the circular surface 41 is rotated 180 about the rotation axis D under the laser-deposition welding heads 3 such that their laser welding spots 31 on the circular surface 41 would circularly run over the surface 41 when the laser-deposition welding heads 3 are at rest; and simultaneously the laser-deposition welding heads 3 are moved 190 in the direction of the rotation axis D such that the material M is deposited in spiral-shaped adjoining or partially overlapping deposition welding tracks MS by area on the circular surface 41.

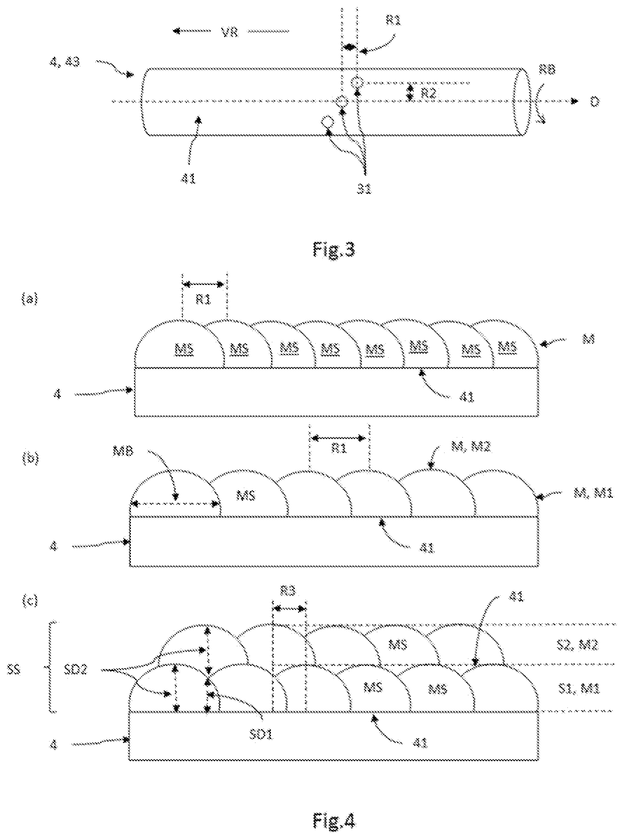

FIG. 3 shows a perspective view of a shaft 43 as an example of a rotationally symmetrical component 4 having the dynamic behaviour of the laser welding spots 31 during laser-deposition welding of an apparatus 1 according to the invention, in this embodiment with three laser-deposition welding heads 3, which are not shown in detail here for clarity reasons, for (quasi-)simultaneous deposition 110 of material M onto the surface 41 of the shaft 43. In other embodiments, the number of laser-deposition welding heads may also be two, four, five or more, wherein the maximum number is limited only by the size of the laser-deposition welding heads 3 and the available space above the component 4. The three laser-deposition welding heads 3 each produce a laser welding spot 31 on the surface 41 of the component 4 and adjacent laser welding spots 31 have a first offset R1 from one another perpendicular to a feed direction VR of the laser welding spots 31 on the surface 41 of the component 4, in which the first offset R1 of adjacent laser welding spots 31 is between 10% and 90%, preferably between 40% and 60%, most preferably 50%, of the material width MB of the deposition welding track MS. Likewise, the adjacent laser welding spots 31 on the surface 41 of the component 4 have a second offset R2 from one another in the feed direction VR, which offset is set in such a way that temperature profiles induced by the laser welding spots 31 on the surface 41 overlap to such an extent that the material M in an overlap region of adjacent deposition welding tracks MS still has a residual heat that is usable/admissible for the process; the same applies here as for FIG. 2. In order to deposit the material M, the rotationally symmetrical surface 41, which in this case is the cylindrical surface of the shaft 43, is in this case rotated 200 about the rotation axis D under the laser-deposition welding heads 3 such that their laser welding spots 31 on the rotationally symmetrical surface 41 would circularly run over the surface 41 when the laser-deposition welding heads 3 are at rest; and the laser-deposition welding heads 3 are moved 210 in the feed direction VR parallel to the rotation axis D such that the material M is deposited in spiral-shaped deposition welding tracks MS by area on the rotationally symmetrical surface 41. The preceding movement 210 is a relative movement, wherein either the laser-deposition welding heads 3 (in any desired number) are moved over the shaft 43 or the shaft 43 is moved under the laser-deposition welding heads 3. For this purpose, the shaft 43 can be clamped in a corresponding movement unit for rotation and, optionally, for longitudinal movement.

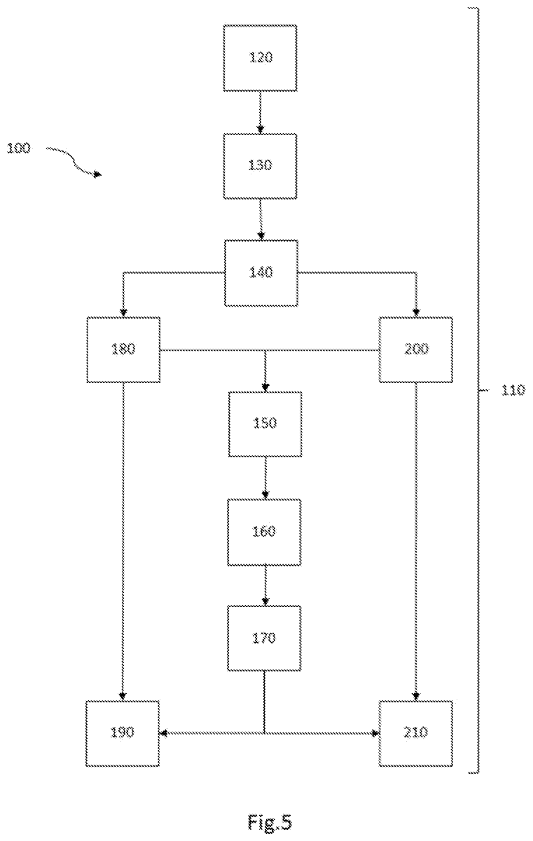

FIG. 4 shows an exemplary side view of deposition welding tracks MS deposited by area using the apparatus according to the invention, (a) as a single layer, (b) as a single layer with a larger first offset R1 compared to FIG. 4a, and (c) of a multilayer system composed of the layers S1 and S2 as a two-layer system, by way of example. In FIG. 4c, the laser-deposition welding heads 3 have been guided in such a way that, after the material M was deposited as the preceding layer S1 by area on the surface 41 of the component 4, a further areal deposition of the material M as the subsequent layer S1 onto the preceding layer S1 was carried out in order to deposit the material as a two-layer system SS, wherein the deposition welding tracks MS of the subsequent layer S2 have a third offset R3 perpendicular to the feed direction VR relative to the underlying deposition welding tracks MS of the preceding layer S1. Since the deposited layers S1, S2 have a varying layer thickness with a smaller layer thickness SD1 and a larger layer thickness SD2, the third offset R3 of the deposition welding tracks of the two superimposed layers S1, S2 was set in such a way that the larger layer thicknesses SD2 of the subsequent layer are arranged above the smaller layer thicknesses SD1 of the preceding layer S1 in order to minimise the resulting undulation of the surface of the two-layer system. The same applies to multilayer systems composed of more than two layers. In this respect, the layers S1, S2 of a multilayer system SS can consist of different materials M, for example with first layers S1 made of a first material M1 and second layers S2 made of a second material M2 in the case of the two-layer system shown here.

FIG. 5 shows an embodiment of the method 100 according to the invention for operating an apparatus 1 for laser-deposition welding according to the invention, having a laser-deposition welding unit 2 with multiple laser-deposition welding heads 3 arranged thereon, comprising the step of (quasi-)simultaneously depositing 110 material M onto a surface 41 of a component 4. In this case, the laser-deposition welding heads 3 each produce a laser welding spot 31 on the surface 41 of the component 4. Adjacent laser welding spots 31 can be moved 120 with a first offset R1 from one another perpendicular to a feed direction VR of the laser welding spots 31 on the surface 41 of the component 4. Likewise, adjacent laser welding spots 31 on the surface 41 of the component 4 can be moved 130 with a second offset R2 from one another in the feed direction VR. In this case, the movements of the laser-deposition welding unit 2 and/or of the laser-deposition welding heads 3 and/or of the conveyor units 5 and/or of the laser beam sources 6 can be controlled 140 in order to carry out the laser-deposition welding by means of a control unit 7 suitably connected to these components 2, 3, 5, 6. A multilayer system SS can be deposited 150 onto the surface 41 of the component 4 by suitably guiding the laser-deposition welding heads 3 of the apparatus 1, wherein, after an areal deposition of the material M as a preceding layer S1 onto the surface 41 of the component 4, a further areal deposition of the material M as a subsequent layer S1 onto the preceding layer S1 takes place. In this case, the deposited layers S1, S2 of the multilayer system 5 can have a varying layer thickness, with a smaller layer thickness SD1 and a larger layer thickness SD2. A third offset R3 perpendicular to the feed direction VR can be set 160 between deposition welding tracks MS of the subsequent layer S2 and underlying deposition welding tracks MS of the preceding layer S1, such that the greater layer thicknesses SD2 of the subsequent layer are arranged above the smaller layer thicknesses SD1 of the preceding layer S1. In this case, the conveying units 5 for the laser-deposition welding heads 3 can be controlled 170 in such a way that the layers S1, S2 of the multilayer system SS consist of different materials M, with first layers S1 of a first material M1 and second layers S2 of a second material M2. In an embodiment where the component 4, preferably a brake disc 42, comprises a circular surface 41 which has a rotation axis D and onto which the material is deposited, the method 100 comprises the further steps of rotating 180 the circular surface 41 about the rotation axis D under the laser-deposition welding heads 3 such that their laser welding spots 31 on the circular surface 41 would circularly run over the surface 41 when the laser-deposition welding heads 3 are at rest; and moving 190 the laser-deposition welding heads 3 in the direction of the rotation axis D such that the material M is deposited in spiral deposition welding tracks MS by area on the circular surface 41. In a further embodiment where the component 4, preferably a shaft 43, comprises a rotationally symmetrical surface 41 which has a rotation axis D and onto which the material is deposited, the method 100 comprises the further steps of rotating 200 the rotationally symmetrical surface 41, preferably the cylindrical surface of the shaft 43, about the rotation axis D under the laser-deposition welding heads 3 such that their laser welding spots 31 on the rotationally symmetrical surface 41 would circularly run over the surface 41 when the laser-deposition welding heads 3 are at rest; and moving 210 the laser-deposition welding heads 3 in the feed direction VR parallel to the rotation axis D such that the material M is deposited in spiral deposition welding tracks MS by area on the rotationally symmetrical surface 41.

### LIST OF REFERENCE SIGNS

1 apparatus for laser-deposition welding according to the invention
2 laser-deposition welding unit
3 laser-deposition welding head
31 laser welding spot
4 component
41 surface of the component onto which the material is deposited
42 brake disc
42a screw holes
43 shaft
conveying unit
6 laser beam source
7 control unit
100 method according to the invention for operating an apparatus for laser-deposition welding
110 (quasi-)simultaneous deposition of material (M) onto a surface of a component by means of multiple laser-deposition welding heads
120 moving adjacent laser welding spots with a first offset from one another perpendicular to a feed direction of the laser welding spots
130 moving adjacent laser welding spots with a second offset from one another in the feed direction
140 controlling at least the movements of the laser-deposition welding unit and/or of the laser-deposition welding heads and of at least the conveying units and/or laser beam sources by means of a suitably connected control unit
150 depositing a multilayer system onto the surface of the component
160 setting a third offset perpendicular to the feed direction between deposition welding tracks of the subsequent layer and underlying deposition welding tracks of the preceding layer
170 controlling the conveying units for the laser-deposition welding heads in such a way that the layers of the multilayer system consist of different materials
180 rotating the circular surface about the rotation axis of the surface under the laser-deposition welding heads
190 moving the laser-deposition welding heads in the direction of the rotation axis of the surface
200 rotating the rotationally symmetrical surface about the rotation axis under the laser-deposition welding heads
210 moving the laser-deposition welding heads in the feed direction parallel to the rotation axis
D rotation axis of the component during laser-deposition welding
M material to be deposited
MB material width of the deposition welding track
MS deposition welding track of the applied material on the surface of the component
L laser radiation
R1 first offset of adjacent laser welding spots from one another perpendicular to the feed direction
R2 second offset of adjacent laser welding spots from one another in the feed direction
R3 third offset of the deposition welding tracks of superimposed layers perpendicular to the feed direction
RB direction of rotation of the component
S1 first layer of material deposited by area
S2 second layer of material deposited by area
SD1 smaller layer thicknesses
SD2 larger layer thicknesses
SS multilayer system
VR feed direction

1-22. (canceled)

23. An apparatus for laser-deposition welding, having a laser-deposition welding unit with multiple laser-deposition welding heads arranged thereon for (quasi-)simultaneous depositing of material (M) onto a surface of a component and having one or more conveying units for supplying the laser-deposition welding heads with the material (M) to be applied and having one or more laser beam sources for supplying the laser-deposition welding heads with laser radiation (L) for carrying out the laser-deposition welding.

24. The apparatus according to claim 23, wherein
the laser-deposition welding heads each produce a laser welding spot on the surface of the component, and adjacent laser welding spots have a first offset (R1) from one another perpendicular to a feed direction (VR) of the laser welding spots on the surface of the component.

25. The apparatus according to claim 24, wherein
the laser welding spots produce deposition welding tracks (MS) with a material width (MB) along the feed direction (VR) on the surface, in which welding tracks the first offset (R1) of adjacent laser welding spots is between 10% and 90%, preferably between 40% and 60%, most preferably 50%, of the material width (MB) of the deposition welding track (MS).

26. The apparatus according to claim 24, wherein
the adjacent laser welding spots on the surface of the component have a second offset (R2) from one another in the feed direction (VR).

27. The apparatus according to claim 26, wherein
the second offset (R2) is set in such a way that temperature profiles induced by the laser welding spots on the surface overlap to such an extent that the material (M) in an overlap region of adjacent deposition welding tracks (MS) still has a residual heat that is usable/admissible for the process.

28. The apparatus according to claim 23, wherein
the apparatus is configured, after an areal deposition of the material (M) as a preceding layer (S1) onto the surface of the component, to guide the laser-deposition welding heads in such a way that a further areal deposition of the material (M) as a subsequent layer (S1) onto the preceding layer (S1) is carried out in order to deposit the material as a multilayer system (SS).

29. The apparatus according to claim 28, wherein
the deposition welding tracks (MS) of the subsequent layer (S2) are deposited onto the preceding layer (S1) with a third offset (R3) perpendicular to the feed direction (VR) relative to the underlying deposition welding tracks (MS) of the preceding layer (S1).

30. The apparatus according to claim 29, wherein
the deposited layers (S1, S2) have a varying layer thickness with a smaller layer thickness (SD1) and a larger layer thickness (SD2), wherein the third offset (R3) of the deposition welding tracks of superimposed layers (S1, S2) is set in such a way that the larger layer thicknesses (SD2) of the subsequent layer are arranged above the smaller layer thicknesses (SD1) of the preceding layer (S1).

31. The apparatus according to claim 23, wherein
the apparatus is configured to supply, by suitable control of the conveying units, the laser deposition welding heads with different materials for deposition onto the surface of the component.

32. The apparatus according to claim 31, wherein
the control is carried out in such a way that layers (S1, S2) of a multilayer system (SS) consist of different materials (M), with first layers (S1) of a first material (M1) and second layers (S2) of a second material (M2).

33. The apparatus according to claim 23, wherein
the laser-deposition welding unit is, in order to perform a movement relative to the surface of the component, arranged in the apparatus so as to be movable, preferably by means of a movement unit.

34. The apparatus according to claim 23, wherein
the laser-deposition welding heads are, in order to perform a movement relative to one another, arranged in the apparatus so as to be movable, preferably by means of a laser-deposition welding head movement unit.

35. The apparatus according to claim 23, wherein
the apparatus comprises a control unit designed to suitably control at least the movements of the laser-deposition welding unit and/or of the laser-deposition welding heads and/or the conveying units and/or of the laser beam sources in order to carry out the laser-deposition welding, for which purpose the control unit is suitably connected to these components.

36. A method for operating an apparatus for laser-deposition welding according to claim 23, having a laser-deposition welding unit with multiple laser-deposition welding heads arranged thereon, comprising the step of (quasi-)simultaneously depositing material (M) onto a surface of a component.

37. The method according to claim 36, wherein the laser-deposition welding heads each produce a laser welding spot on the surface of the component, comprising the further step of moving adjacent laser welding spots with a first offset (R1) from one another perpendicular to a feed direction (VR) of the laser welding spots on the surface of the component.

38. The method according to claim 37, comprising the further step of moving adjacent laser welding spots on the surface of the component with a second offset (R2) from one another in the feed direction (VR).

39. The method according to claim 36, comprising the further step of controlling at least the movements of the laser-deposition welding unit and/or of the laser-deposition welding heads and/or of the conveying units and/or of the laser beam sources in order to carry out the laser-deposition welding by means of a control unit suitably connected to these components.

40. The method according to claim 36, comprising the further step of depositing a multilayer system (SS) onto the surface of the component by suitably guiding the laser-deposition welding heads of the apparatus, in which, after an areal deposition of the material (M) as a preceding layer (S1) onto the surface of the component, a further areal deposition of the material (M) as a subsequent layer (S1) onto the preceding layer (S1) takes place.

41. The method according to claim 40, wherein the deposited layers (S1, S2) of the multilayer system (S) have a varying layer thickness with a smaller layer thickness (SD1) and a larger layer thickness (SD2), comprising the further step of setting a third offset (R3) perpendicular to the feed direction (VR) between deposition welding tracks (MS) of the subsequent layer (S2) and underlying deposition welding tracks (MS) of the preceding layer (S1) such that the larger layer thicknesses (SD2) of the subsequent layer are arranged above the smaller layer thicknesses (SD1) of the preceding layer (S1).

42. The method according to claim 40, comprising the further step of controlling the conveying units for the laser-deposition welding heads in such a way that the layers (S1, S2) of the multilayer system (SS) consist of different materials (M), with first layers (S1) of a first material (M1) and second layers (S2) of a second material (M2).

43. The method according to claim 36, wherein the component, preferably a brake disc, comprises a circular surface which has a rotation axis (D) and onto which the material is deposited, comprising the further steps of
rotating the circular surface about the rotation axis (D) under the laser-deposition welding heads such that their laser welding spots on the circular surface would circularly run over the surface when the laser-deposition welding heads are at rest; and
moving the laser-deposition welding heads in the direction of the rotation axis (D) such that the material (M) is deposited in spiral deposition welding tracks (MS) by area of the circular surface.

44. The method according to claim 36, wherein the component, preferably a shaft, comprises a rotationally symmetrical surface which has a rotation axis (D) and onto which the material is deposited, comprising the further steps of
rotating the rotationally symmetrical surface, preferably the cylindrical surface of the shaft, about the rotation axis (D) under the laser-deposition welding heads such that their laser welding spots on the rotationally symmetrical surface would circularly run over the surface when the laser-deposition welding heads are at rest; and
moving the laser-deposition welding heads in the feed direction (VR) parallel to the rotation axis (D) such that the material (M) is deposited in spiral deposition welding tracks (MS) by area on the rotationally symmetrical surface.
